(19) United States
(12) Patent Application Publication
(10) Pub. No.: US 2011/0317971 A1
(43) Pub. Date: Dec. 29, 2011

(54) CABLE MANAGEMENT PANEL

(75) Inventors: Li Zhang, Shanghai (CN); Zong-sheng Leng, Shanghai (CN); Peng Cui, Liaonging (CN); Thomas Chan, Singapore (SG)

(73) Assignee: ADC Communications (Shanghai) Co., Ltd., Shanghai (CN)

(21) Appl. No.: 12/992,480

(22) PCT Filed: May 12, 2009
(86) PCT No.: PCT/CN2009/071753

§ 371 Date: Jul. 1, 2011

(30) Foreign Application Priority Data
May 12, 2008 (CN) 200810128761.X

(51) Int. Cl. G02B 6/44

(52) U.S. Cl. 385/135

(57) ABSTRACT

A cable management panel having a chassis and a sliding drawer. The drawer having a cable storage region, a cable splice region, and a cable termination region. The cable management panel including cable guides that define an incoming cable pathway to the cable storage region, and then to the cable splice region; an intermediate cable pathway to the cable termination region, and an outgoing cable pathway. The outgoing cable pathway having an S-curved cable routing configuration when the sliding drawer is closed. The chassis of the cable management panel defining an interior sized for receipt of one two-rack-unit drawer, or in the alternative, two one-rack-unit drawers.

### CROSS-REFERENCE TO RELATED APPLICATIONS

This application claims the benefit of Chinese Patent Application Serial No. 200810128761.X, filed May 12, 2008; which application is incorporated herein by reference.

### TECHNICAL FIELD

This disclosure relates generally to devices for management of telecommunication cables and associated methods. More particularly, this disclosure relates to a cable management panel used in the telecommunications industry for managing fiber optic cables, and associated methods.

### BACKGROUND

Cable management arrangements for cable termination, splice, and storage come in many forms. One cable management arrangement used in the telecommunications industry today includes sliding drawers installed on telecommunication equipment racks. The drawers provide organized, high-density, cable termination, splice, and storage in telecommunication infrastructures that often have limited space. There is a continued need in the art for devices and arrangements that improve upon existing cable management arrangements.

### SUMMARY

The present disclosure relates to a cable management panel having a chassis and a sliding drawer. One aspect of the invention relates to the chassis having a rear incoming cable opening, a side outgoing cable opening, and cable guides and pathways that accommodate the sliding movement of the drawer relative to the chassis and the chassis openings; the cable guides and pathways further provide cable bend protection of cables routed between cable storage, cable splice, and cable terminations regions of the drawer. Another aspect of the invention relates to the chassis being constructed to receive one two-rack-unit drawer or two one-rack-unit drawers.

A variety of examples of desirable product features or methods are set forth in part in the description that follows, and in part will be apparent from the description, or may be learned by practicing various aspects of the disclosure. The aspects of the disclosure may relate to individual features as well as combinations of features, including combinations of features disclosed in separate embodiments. It is to be understood that both the foregoing general description and the following detailed description are explanatory only, and are not restrictive of the claimed invention.

### BRIEF DESCRIPTION OF THE DRAWINGS

FIG. 1 is a front perspective view of one embodiment of a cable management panel, in accordance with the principles disclosed;

FIG. 2 is an exploded, front perspective view of another embodiment of a cable management panel, in accordance with the principles disclosed, the cable management panel including one two-rack-unit drawer;

FIG. 3 is an exploded, front perspective view of the cable management panel of FIG. 1, the cable management panel including two one-rack-unit drawers;

FIG. 4 is a rear perspective view of one of the one-rack-unit drawers of the cable management panel of FIG. 3;

FIG. 5 is a partially exploded rear perspective view of the drawer of FIG. 4;

FIG. 6 is a partially exploded front perspective view of the drawer of FIG. 4;

FIG. 7 is top plan view of one drawer illustrating a rear entry cable routing configuration;

FIG. 8 is a top plan view of the drawer of FIG. 7 illustrating a side entry cable routing configuration;

FIG. 9 is a rear perspective view of the two-rack-unit drawer of the cable management panel of FIG. 2;

FIG. 10 is a partially exploded rear perspective view of the drawer of FIG. 9;

FIG. 11 is a partially exploded front perspective view of the drawer of FIG. 9;

FIG. 12 is a top perspective view of an alternative embodiment of a two-rack-unit drawer that can used in the present cable management panel;

FIG. 13 is a front schematic representation of a telecommunications system, including a rack having a number of cable management panels mounted thereon;

FIG. 14 is a front perspective view of still another embodiment of a cable management panel, in accordance with the principles disclosed;

FIG. 15 is an exploded view of the cable management panel of FIG. 14;

FIG. 16 is a partially exploded front perspective view of a drawer of the cable management panel of FIG. 14;

FIG. 17 is a partially exploded view of the cable management panel of FIG. 14;

FIG. 18 is a top perspective view of the cable management panel of FIG. 14, shown without a top wall and illustrated with the drawer in an open position;

FIG. 19 is a further partially exploded view of the drawer of FIG. 16;

FIG. 20 is a further partially exploded view of the drawer of FIG. 19;

FIG. 21 is a top plan view of the drawer of FIG. 14, shown without the top wall and illustrated with the drawer in a closed position;

FIG. 22 is a top plan view of the drawer of FIG. 21, illustrated with the drawer in the open position; and

FIG. 23 is a top plan view of the drawer of FIG. 22, illustrated without a cable storage tray.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

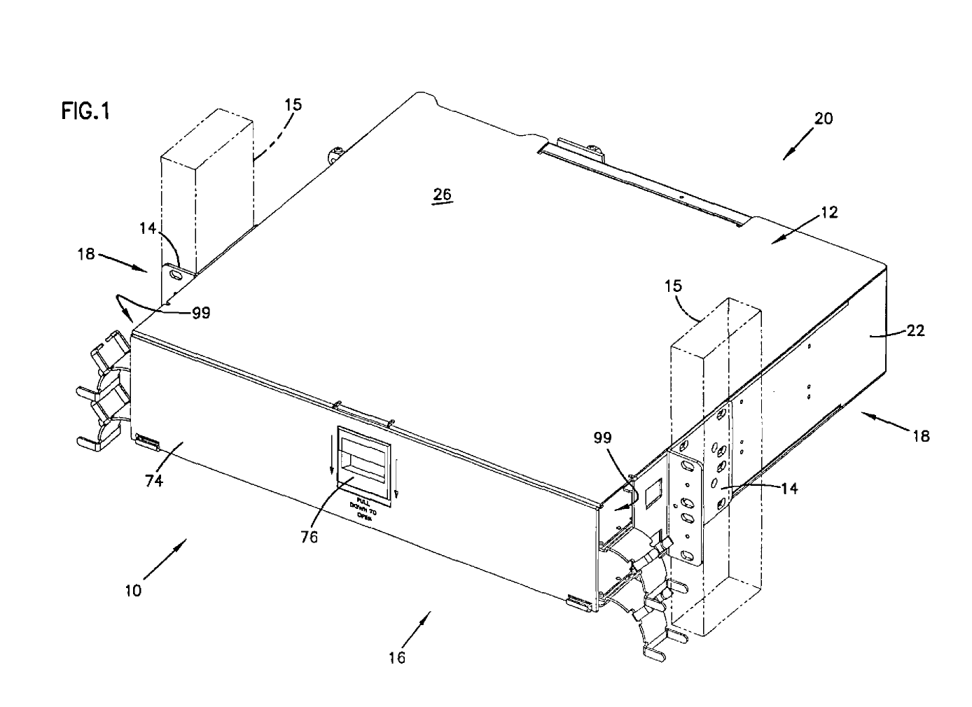

Referring to FIG. 1, a cable management panel or module 10 according to the present invention is shown. The panel 10 includes a frame or chassis 12 having mounting brackets 14 used to mount the panel 10 to a telecommunications structure, such as a telecommunications rack (only partially and schematically represented at 15). The cable management panel 10 can also be configured for mounting within a cabinet, enclosure, or on other mounting fixtures or framework.

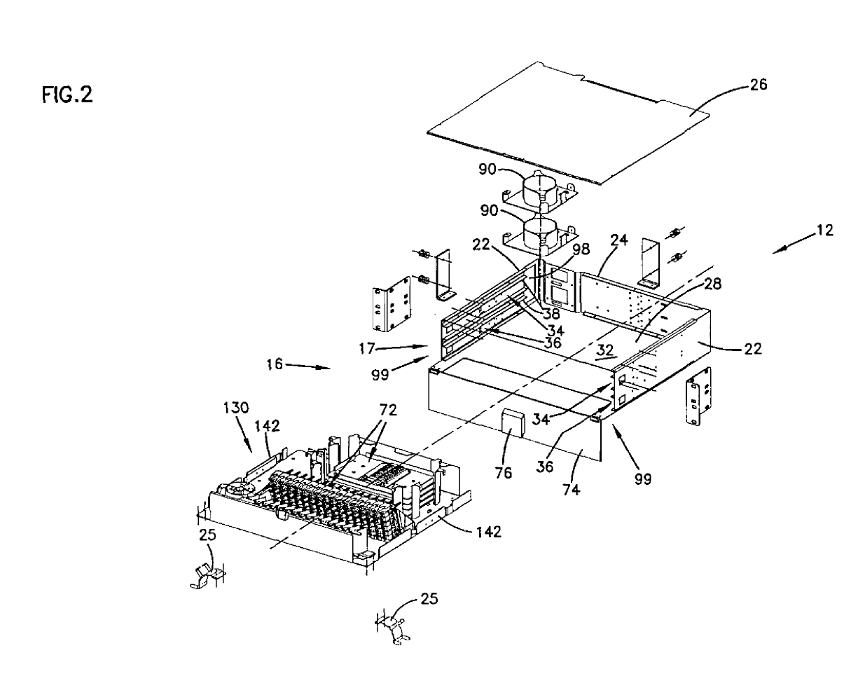

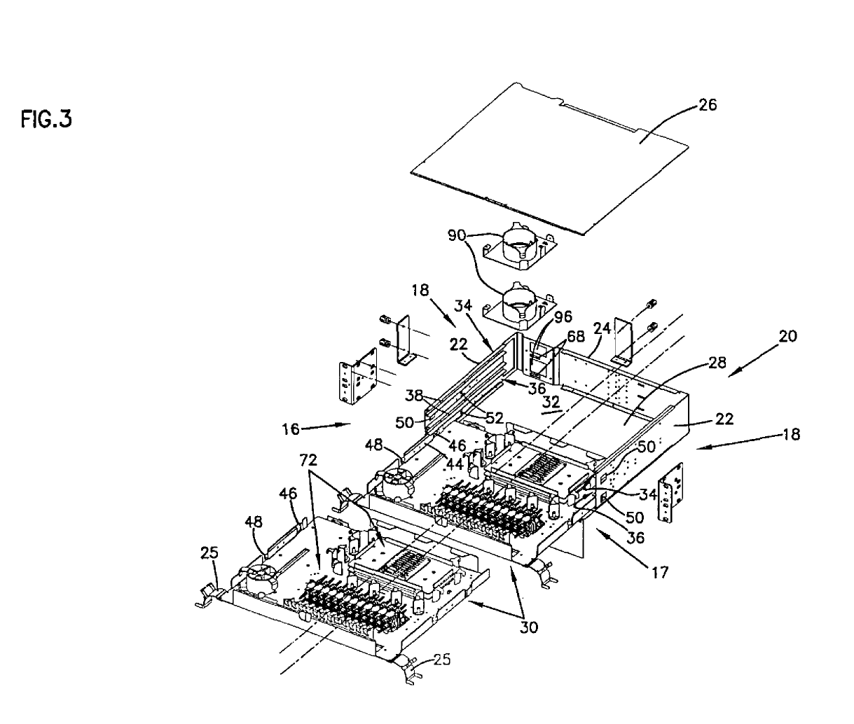

Referring to FIGS. 1 and 3, the chassis 12 of the cable management panel 10 generally has a front 16 that defines a front opening 17 (see also FIG. 2), opposite sides 18, and a rear 20. The sides 18 are defined by sidewalls 22, and the rear is defined by a rear wall 24. The chassis 12 further includes a top wall 26 and an opposite bottom wall 28. The front opening 17 may be enclosed by a front cover 74. In the illustrated embodiment, the front cover 74 (FIG. 2) is hinged to the bottom wall 28. A front latch 76 (FIG. 1) is provided to secure the front cover 74 in a closed position.

Referring now to FIG. 3, the cable management panel 10 includes a least one drawer 30 that slides between an opened position and a closed position. In the opened position, cables and components contained on the drawer 30 can be accessed for maintenance or repair purposes, for example. In the closed position, the cables and components are enclosed and protected within a non-partitioned interior region 32 of the chassis 12. What is meant by “non-partitioned” is that the interior region 32 is open and generally non-obstructed by a dividing wall or panel, for example.

Referring now to FIGS. 2 and 3, the chassis 12 of the cable management panel 10 of the present disclosure includes a first pair of drawer guides 34 and a second pair of drawer guides 36. The first and second pairs of drawer guides 34, 36 are provided within the interior region 32 of the chassis 12. In the illustrated embodiment, each of the pairs of drawer guides 34, 36 include channeled rails or structures 38 attached to the sidewalls 22 of the chassis. The channeled rails 38 are aligned and arranged to define an upper pair of channeled rails (e.g., 34) and a lower pair of channel rails (e.g., 36).

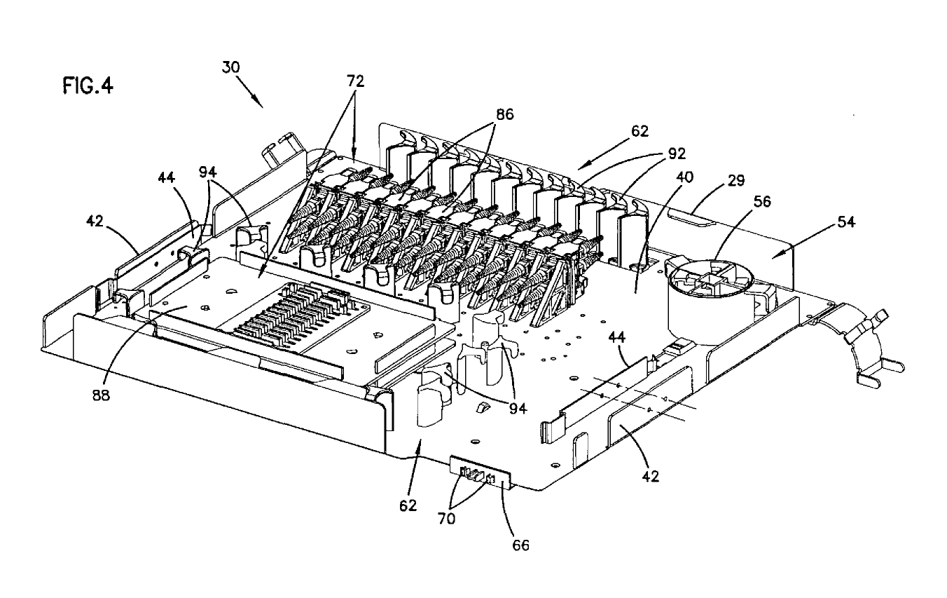

Referring to FIGS. 3 and 4, the sliding drawer 30 of the cable management panel 10 is engaged with one of the first and second pairs of drawer guides 34, 36 to permit sliding movement of the drawer 30 relative to the chassis 12. In particular, the drawer 30 includes a drawer bottom 40 (FIG. 4) and upright sides 42 that extend upward from the drawer bottom 40. The upright sides 42 engage the channeled rails 38 of the upper or lower pair of drawer guides 34, 36 to permit the sliding movement of the drawer.

The non-partitioned interior region 32 of the chassis 12 is sized and constructed to receive two one-rack-unit drawers, as shown in FIG. 3. A “rack unit” is known to those of skill in the art generally as a standard unit of volume within a telecommunications rack. The size of equipment can be referred to by the number of rack units occupied by that piece of equipment. In FIG. 3, each individual drawer 30 occupies a single rack unit; the chassis 12 of the cable management panel 10 is sized to receive two of the one-rack-unit drawers 30. As can be understood, the upright sides 42 of the upper drawer engage the channeled rails 38 of the upper pair of drawer guides 34 and the upright sides of the lower drawer engage the channeled rails 38 of the lower pair of drawer guides 36.

The non-partitioned interior region 32 of the drawer 30 is also sized and constructed to receive one two-rack-unit drawer 130, as shown in FIG. 2. When a two-rack-unit drawer is installed within the chassis 12, the upright sides 142 of the drawer (e.g., 130) engage the channeled rails 38 of the lower pair of drawer guides 36. The channeled rails 38 of the upper pair of drawer guides 34 have a low profile so as not to obstruct receipt and sliding movement of the two-rack-unit drawer 130.

Referring now to FIGS. 4-6, the cable management panel 10 further includes a spring lock clip 44. In the illustrated embodiment, the panel 10 includes two spring lock clips 44 that are carried by the drawer 30 during sliding movement of the drawer. The spring lock clips 44 are secured to the upright sides 42 of the drawer 30.

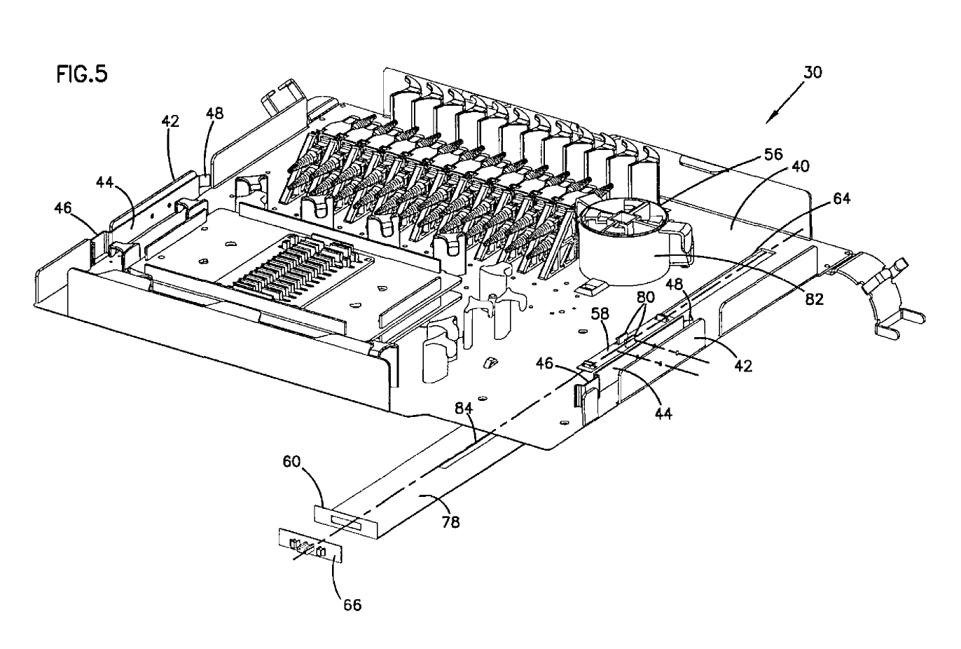

Each spring lock clip 44 has a first tab end 46 (FIG. 5) and a second tab end 48. The tab ends 46, 48 partly extend through breaks or openings in the upright sides 42 of the drawer. The first tab end 46 engages a first aperture 50 (FIG. 3) formed in the chassis when the drawer is in the open position. The first tab end 46 defines a positive mechanical lock that locks the drawer in the open position to prevent inadvertent closing movement while accessing the drawer interior. To unlock the drawer 30 from the locked opened position, the first tab ends 46 of the clips 44 are press inward until disengaged from the first aperture 50; the drawer is then free to slide toward the closed position. As shown in FIG. 3, the positive mechanical locks defined by the apertures 50 and first tab ends 46 of the clips 44 are located adjacent to the front 16 of the chassis 12 for access from an exterior of the chassis 12.

The second tab end 48 of each spring lock clip 44 engages a second aperture 52 (FIG. 3) formed in the chassis when the drawer is in the closed position. The second tab end 48 defines a friction-type lock that holds the drawer in the closed position to prevent inadvertent opening movement. The second tab end 48 is constructed such that to open the drawer 30 from the closed position, the user simply pulls the drawer forward. The pulling force overcomes the frictional hold of the drawer 30 and disengages the second tab end 48 of the spring lock clip 44 from the second aperture 52; the drawer is then free to slide toward the open position.

Referring still to FIGS. 4-6, the cable management panel 10 further includes a cable manager 54 that accommodates cable slack during sliding movement of the drawer 30 relative to the chassis 12. The cable manager 54 includes a radius limiter 56, a floating attachment piece 58 (FIG. 5), and a stationary plate extension 78. The radius limiter 56 is attached to projections 80 formed on the floating attachment piece 58. The floating attachment piece 58 is in turn slidingly attached to the stationary plate extension 78 through a slot 64 form in the drawer bottom 40. The radius limiter 56 of the cable manager 54 has a curved body structure 82 that also protects cables from damage by limiting cable bending beyond a minimum bend radius.

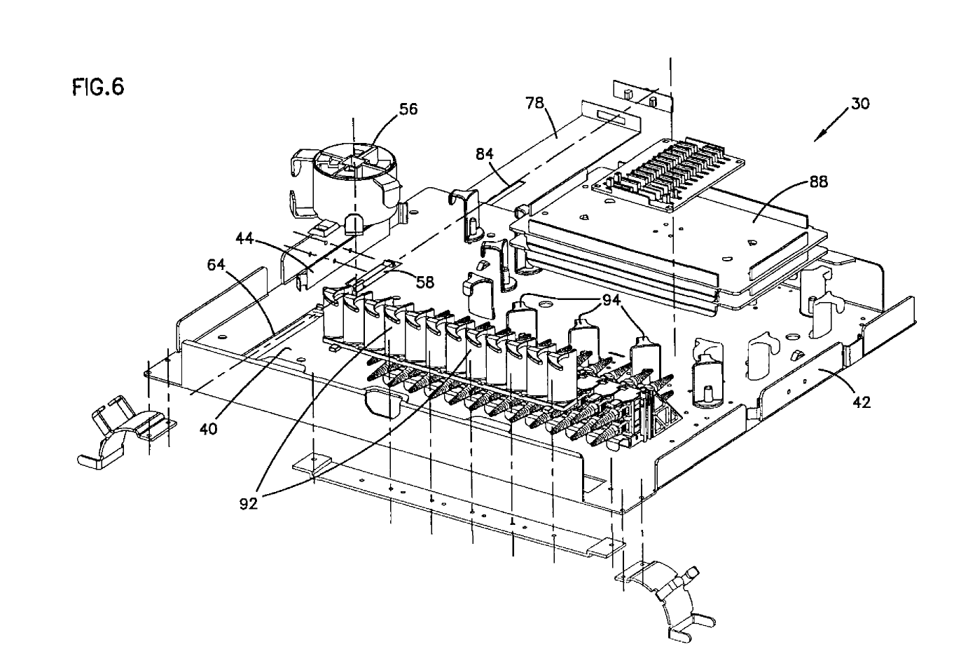

Referring to FIGS. 5 and 6, the plate extension 78 is located beneath the drawer 30. The floating attachment piece 58 is slidingly attached to a slot 84 formed in the plate extension 78. The plate extension 78 remains stationary relative to the chassis 12 during sliding movement of the drawer 30; the slot 84 of the plate extension 78 and the slot 64 of the drawer bottom 40 permit the radius limiter 56 to slide and/or float along the drawer bottom 40 as needed to accommodate cable slack during movement of the drawer 30. What is meant by “float” is that the radius limiter 56 is able to move independently of the drawer and relative to the chassis within a range of motion as needed to accommodate the pull or push of cables wrapped about the radius limiter. The range of motion is determined in part by the slot 84 of the stationary plate extension 78 which functions to limit the movement of the radius limiter 56 and in turn permits the drawer 30 to slide relative to the radius limiter 56. Further details of a radius limiter arrangement having a similar slotted, stationary cable manager component are described in U.S. Pat. No. 5,066,149; which disclosure is incorporated herein by reference.

Referring to FIGS. 3-5, a releasable latch 66 (FIGS. 4 and 5) is provided at a first end 60 of the stationary plate extension 78. The first end 60 of the stationary plate extension 78 is attached to the chassis 12 by the releasable latch 66. In particular, the latch 66 extends through an opening 68 formed in the rear wall 24 of the chassis 12. Opposing flexible latch arms 70 snap-fit to the opening 68 of the chassis. The latch 66 secures the plate extension 78 in a stationary position for purposes of causing the relative movement between the drawer 30 and the radius limiter 56, as described above. The latch also prevents inadvertent separation of the drawer 30 from the chassis 12.

The latch 66 is accessible from an exterior of the chassis 12, and is releasable so that the sliding drawer 30 can be selectively separated from the chassis 12. To separate and remove the drawer 30 from the chassis 12, the latch arms 70 of the latch 66 are flexed toward one another to disengage the rear wall opening 68.

Referring again to FIG. 4, the cable management panel 10 can include a variety of cable connections 72 that provide or accommodate telecommunications service. In the illustrated drawer embodiment, the cable connections 72 include integrated cable terminations and splice connections. The splice connections can include one or more stackable splice tray modules 88. The cable terminations can include sliding adapter packs or modules 86 having adapters that receive fiber optic connectors. Further details of an example sliding adapter arrangement that can be used in accordance with the principles disclosed are described in U.S. Pat. No. 5,497,444 and U.S. Pat. No. 6,591,051; the disclosures of which are hereby incorporated by reference. In the illustrated embodiment of FIG. 4, the splice tray modules 88 and adapter packs 86 accommodate up to 24 cable connections or terminations; accordingly a panel having two one-rack-unit drawers 30 accommodates up to 48 cable connections.

As can be understood, the present cable management panel 10 can be configured to provide a number of cable connection configurations, including 12, 14, 48, 72 and 96 termination configurations. As can also be understood, the present drawer 30 can be configured to provide only cable terminations, only cable splicing, or a combination of terminations and splicing. Other drawer configurations can further include attenuators, couplers, switches, and wave division multiplexers (WDMs), for example.

Referring still to FIG. 4, the cable management panel 10 can also include a variety of cable management elements 62 that provide bend radius protection for use with fiber optic cables. The cable management elements 62 can include, for example, a rear spool 90 (FIG. 3) and an array of front guides 92. As will be described in greater detail hereinafter, the rear spool 90 manages cables entering at or adjacent to the rear 20 of the chassis 12, and the array of front guides 92 manages cables exiting at or adjacent to the front 16 of the chassis. Other cable guides, e.g., 94, are positioned at various locations on the drawer 30.

Referring again to FIG. 3, cables connected to the cable connections 72 access the interior region 32 of the chassis 12 by any one of a number of access locations defined by the present chassis 12. The number of access locations includes first and second rear access openings 96 formed in the rear wall 24 of the chassis 12. In the illustrated panel of FIG. 3, the first and second rear access openings 96 correspond to the first and second one-rack-unit drawers 30.

Another access location of the chassis is defined by a rear side access opening 98 formed in one of the opposite sidewalls 22 of the chassis adjacent to the rear wall 24. Still other access locations include first and second front side access openings 99 provided at each of the opposite sidewalls 22 adjacent to the front opening 17 of the chassis (see also FIG. 1).

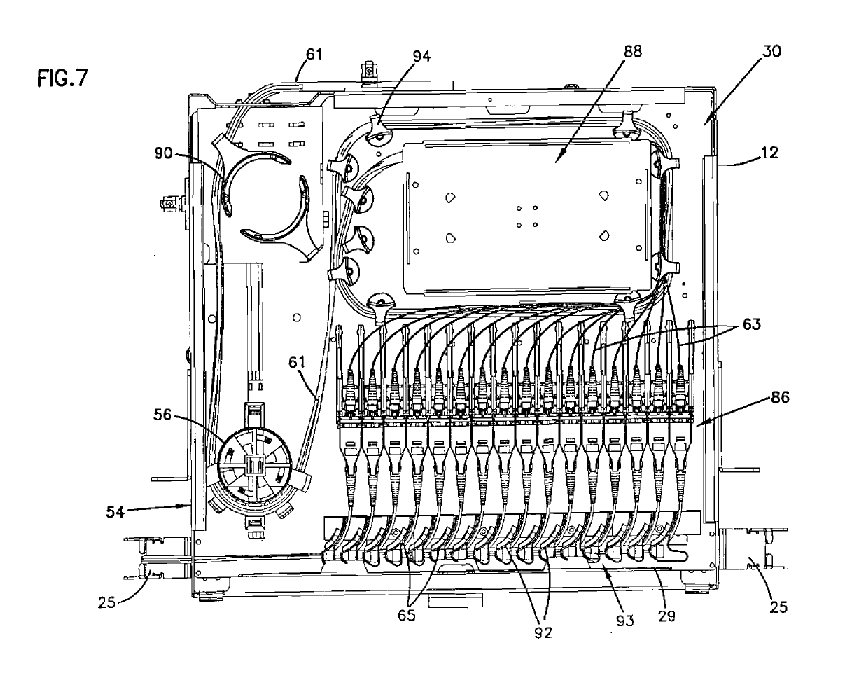

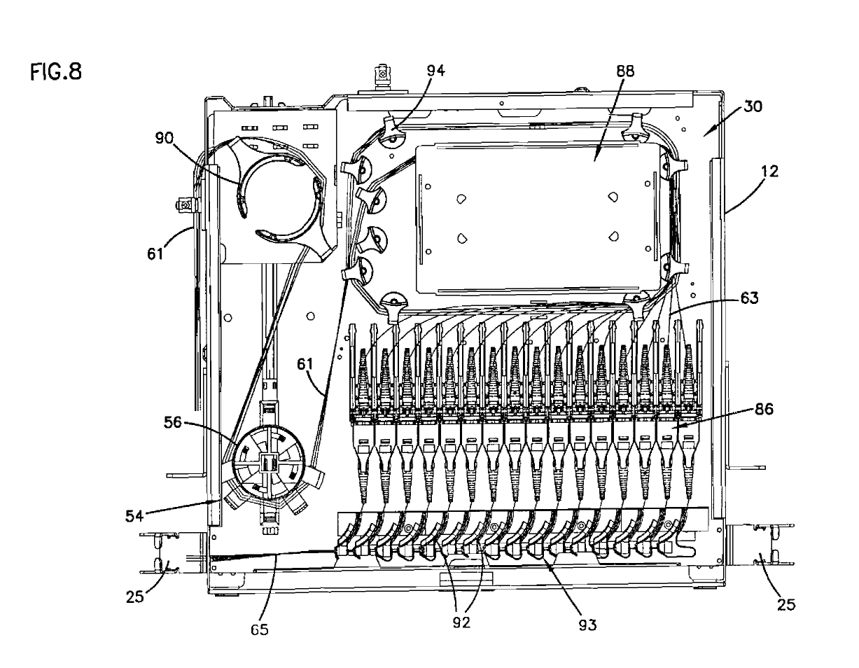

Referring now to FIGS. 7 and 8, the number of access locations defined by the chassis 12 of the present cable management panel 10 accommodates a variety of cable routing alternatives. As shown in FIG. 7, for example, in one routing configuration, an incoming cable 61 enters the rear access opening 96 (FIG. 3) and is guided around the rear spool 90 toward the cable manager 54. The cable 61 wraps about the radius limiter 56 of the cable manager 54 and is directed toward the other cable guides 94 located adjacent to the splice tray modules 88. The cable is spliced and the individual fiber cables 63 of the incoming cable 61 are routed toward and attached to rear connection ends of the adapter modules 86. Fiber cables 65 attached to front connection ends of the adapter modules 86 are routed within the front guides 92 and into a channel 93 located between the array of front guides 92 and a front drawer wall 29 (see also FIG. 4, for example). The fiber cables 65 exit the drawer 30 and the chassis through one of the front side access openings 99, depending upon the desired orientation of the array of front guides 92. In the illustrated embodiment, curved exit devices 25 are provided on the drawer to prevent the exiting fiber cables 65 from exceeding a minimum bend radius.

In the alternative, and referring to FIG. 8, another routing configuration may include routing the incoming cable 61 through the rear side access opening 98. In this routing configuration, the incoming cable 61 is guided around the rear spool 90 in an opposite direction as the previous routing configuration. The incoming cable is then similarly routed to the cable manager 54, about the radius limiter 56 of the cable manager 54, and then toward the other cable guides 94 located adjacent to the splice tray modules 88. The cable is likewise spliced and the individual fiber cables 63 of the incoming cable 61 are routed toward and attached to rear connection ends of the adapter modules 86. Fiber cables 65 attached to front connection ends of the adapter modules 86 are routed within the front guides 92, into the channel 93, and exit the drawer 30 and the chassis through one of the front side access openings 99. As can be understood, either routing configuration may be used in both the one-rack-unit drawer 30 and the two-rack-unit drawer 130.

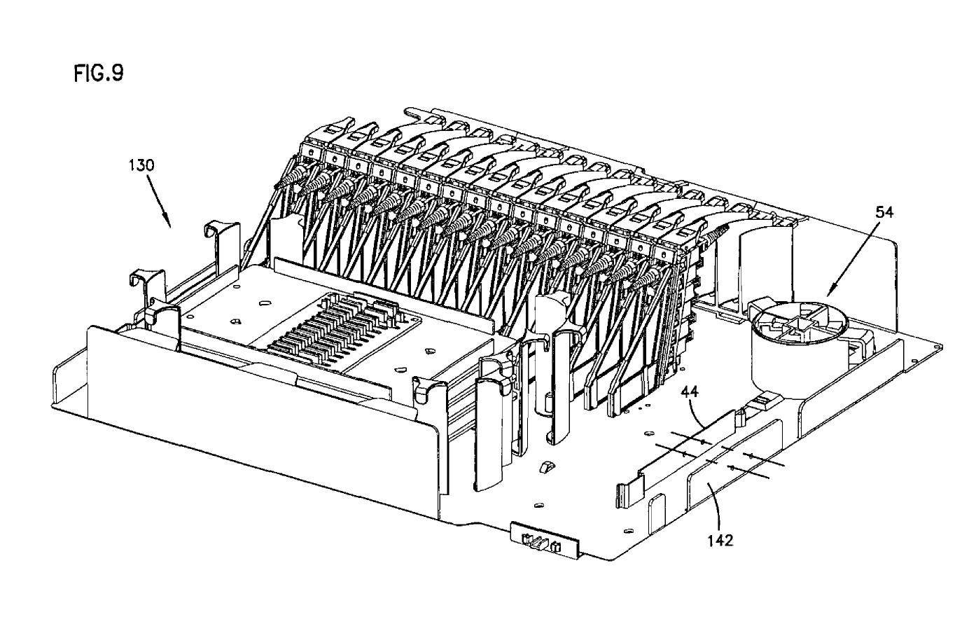

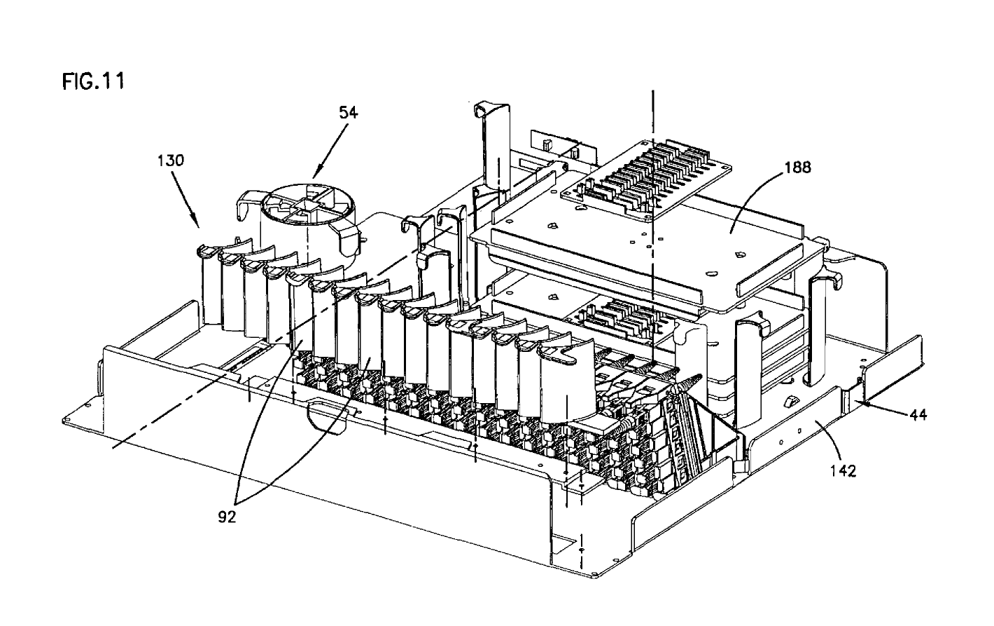

As previously described, the non-partitioned interior region 32 of the chassis 12 is sized and constructed to receive two one-rack-unit drawers (FIG. 3) or one two-rack-unit drawer 130 (FIG. 2). Referring to FIGS. 9-11, one embodiment of the two-rack-unit drawer 130 is illustrated.

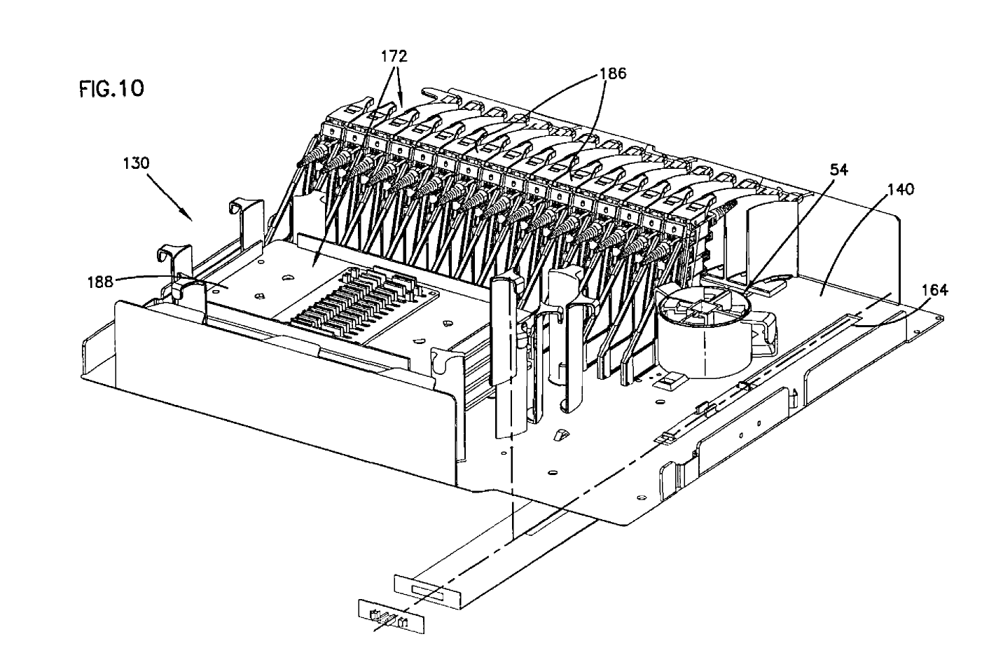

Similar to the one-rack-unit drawer, the two-rack-unit drawer 130 carries two spring lock clips 44 that attach to the upright sides 142 of the drawer. The spring lock clips function as previously described to lock the drawer 130 in the open position and to hold the drawer in the closed position. Also similar to the previous drawer embodiment, the drawer 130 has a drawer bottom 140 (FIG. 10) that defines a slot 164. The cable manager 54 is mounted at the slot 164 to accommodate cable slack during sliding movement of the drawer 130, as previously described.

Referring to FIG. 10, cable connections 172 including integrated cable terminations and splice connections are provided on the drawer 130. The splice connections includes one or more stackable splice tray modules 188. The cable terminations include sliding adapter packs or modules 186 having adapters that receive fiber optic connectors. In the present embodiment, the splice tray modules 188 and adapter packs accommodate up to 96 cable connections or terminations.

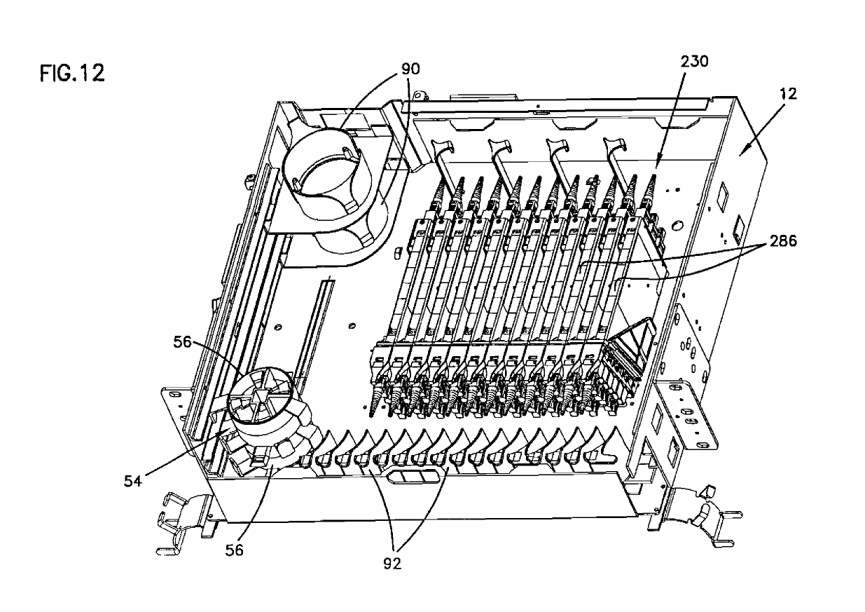

Referring now to FIG. 12, another embodiment of a two-rack-unit drawer 230 is illustrated. In this embodiment, the drawer 230 is loaded with twelve termination modules 286. The termination modules 286 define rear connection locations to which incoming cables are directly coupled. The individual termination modules 286 can each be configured to house various fiber optic equipment including couplers, splitters, combiners, wave division multiplexers, etc.

In some high-density applications having a two-rack-unit drawer, cables may be routed through both the upper and lower rear access openings 96. In such applications, the panel may include stacked spools 90, as shown in FIG. 12, to accommodate the two rear cable entry locations. Such drawers may also include a cable manager 54 having stacked radius limiters 56.

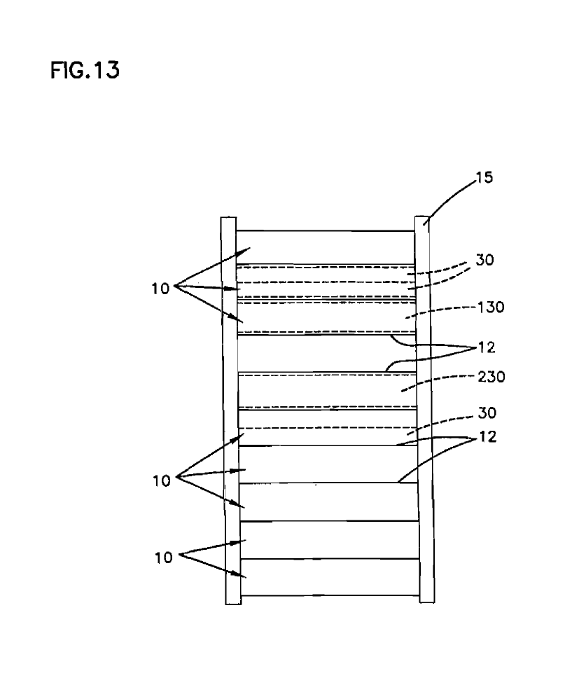

In general, the present cable management panel includes a chassis 12 that can be utilized to provide a variety of fiber termination/distribution arrangements. The advantageous flexibility of the present panel is due in part to the construction of the chassis 12. In particular, and referring now to FIG. 13, during an initial installation period, a user may populate a telecommunications rack 15 or frame with a number of empty cable management panels 10 (i.e., empty chassis 12 with no drawers). Drawers 30, 130, 230 may be installed within some of the empty chassis during the initial installation period to provide telecommunications services based upon present service needs. After the initial installation period and due to subsequent increased service needs, the system can be updated by filling empty chassis with different drawer configurations, on an as-needed basis. This allows the user to customize a growing telecommunications systems based upon future needs that may not be presently determined.

For example, the user can install a single one-rack-unit drawer 30 to add capacity for 24 terminations, install two one-rack-unit drawers 30 to add capacity for 48 terminations, install a two-rack-unit drawer to add capacity for 96 terminations, or install a combination of any of these drawers when the user deems such capacity is required. Further, the drawers can be pre-configured with splice only, termination only, or a combination of slice and terminations during manufacture for quick installation at the user's facility. What is meant by “pre-configured” is that the desired cable connections (e.g., 72) and the cable management elements (e.g., 62) are mounted to or loaded on the drawer at the factory, as opposed to at the user's facility. To install a drawer, the user simply slides the pre-configured drawer into the chassis and snap-fits the rear latch (e.g., 66; FIG. 5) to the chassis. As can be understood, the chassis 12 of the present disclosure is constructed to accommodate a variety of drawer configurations, which allows a user to grow a telecommunications system in a unique customized manner.

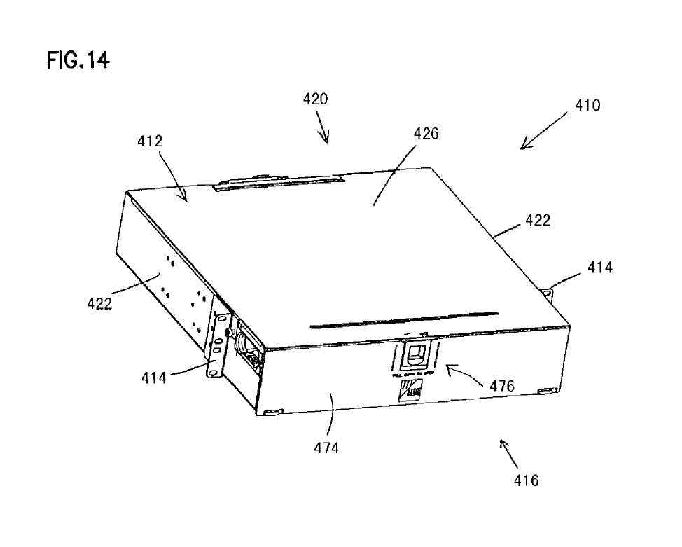

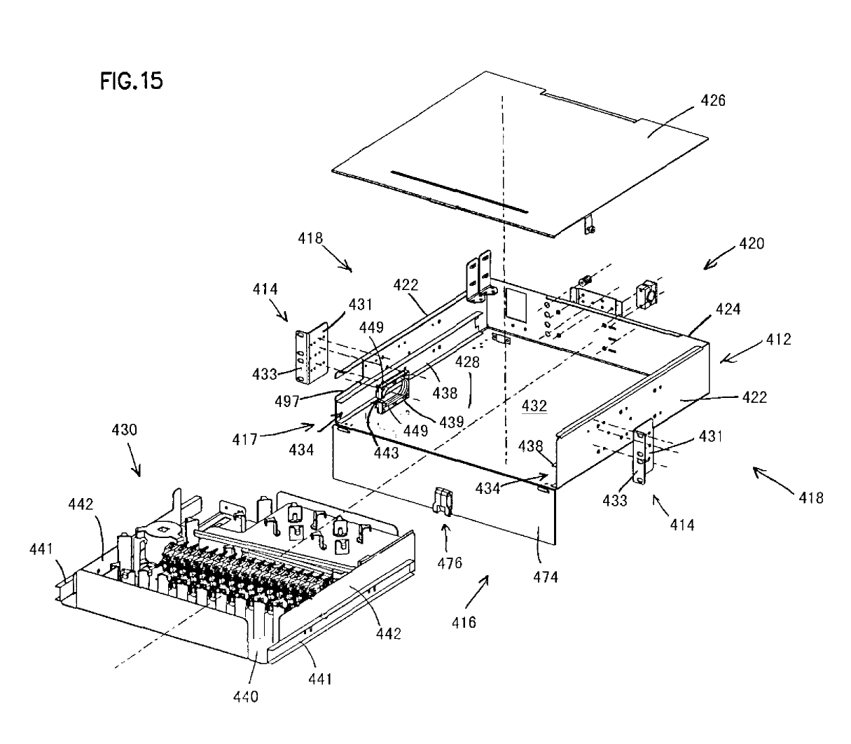

Referring to FIG. 14, another embodiment of a cable management panel or module 410 according to the present invention is illustrated. The panel 410 includes a frame or chassis 412 having mounting brackets 414 used to mount the panel 410 to a telecommunications structure, such as a telecommunications rack (schematically represented at 15 in FIG. 13). In the illustrated embodiment and referring to FIG. 15, the mounting brackets 414 are L-shaped and constructed to mount to either a rack having a 19-inch mounting configuration or a rack having a 23-inch mounting configuration. In particular, the mounting brackets 414 each include a first flange portion 431 and a second flange portion 433. When mounted to a rack with a 19-inch mounting configuration, the first flange portion 431 is secured to the chassis 412 and the second flange portion 433 is secured to the rack. When mounted to a rack with a 23-inch mounting configuration, the second flange portion 433 is secured to the chassis 412 and the first flange portion 431 is secured to the rack. The cable management panel 410 can also be configured for mounting within a cabinet, enclosure, or on other mounting fixtures or framework.

Referring to FIGS. 14 and 15, the chassis 412 of the cable management panel 410 generally has a front 416 that defines a front opening 417, opposite sides 418, and a rear 420. The sides 418 are defined by sidewalls 422, and the rear is defined by a rear wall 424. The chassis 412 further includes a top wall 426 and an opposite bottom wall 428. The front opening 417 may be enclosed by a front cover 474. In the illustrated embodiment, the front cover 474 is hinged to the bottom wall 428. A front latch 476 is provided to secure the front cover 474 in a closed position.

Referring to FIG. 15, the cable management panel 410 includes a least one drawer 430 that slides between an open position and a closed position. In the opened position, cables and components contained on the drawer 430 can be accessed for maintenance or repair purposes, for example. In the closed position, the cables and components are enclosed and protected within a non-partitioned interior region 432 of the chassis 412.

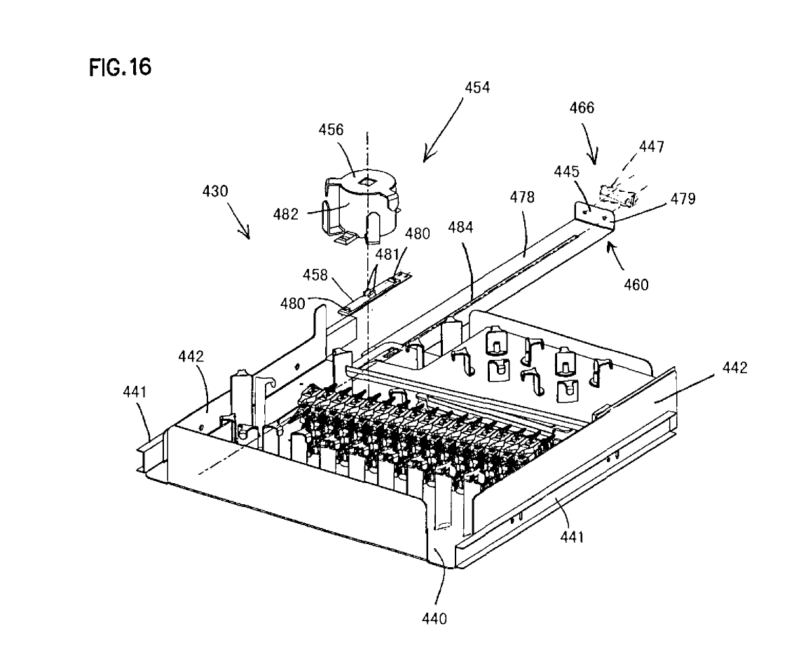

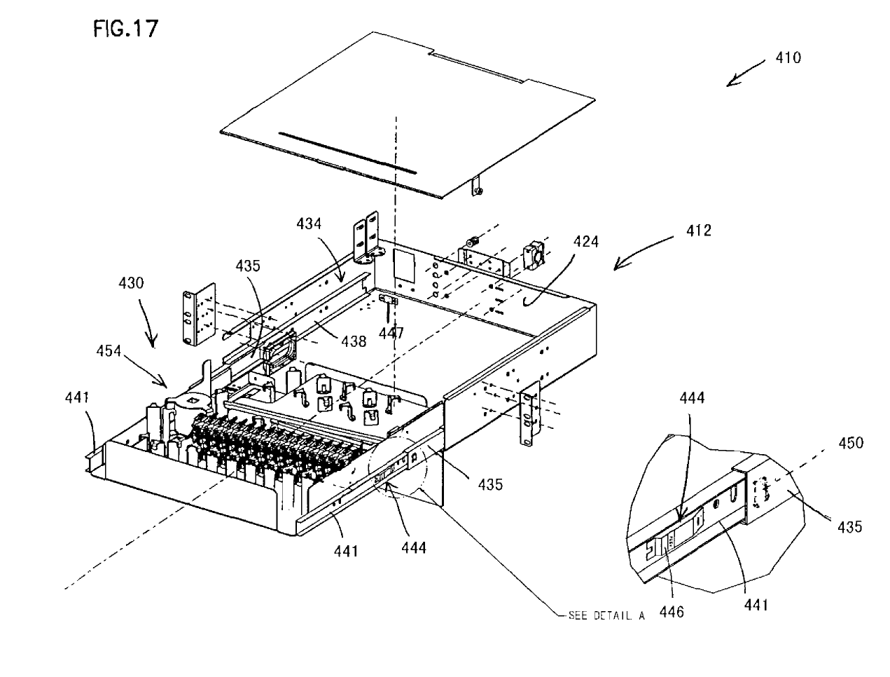

The chassis 412 of FIG. 15 includes only a first pair of drawer guides 434. The first pair of drawer guides is located within the interior region 432 of the chassis 412. The drawer guides 434 include channeled rails or structures 438 attached to the sidewalls 422 of the chassis. The sliding drawer 430 engages the drawer guides 434 to permit sliding movement of the drawer 430 relative to the chassis 412. In this embodiment and referring now also to FIG. 16, the drawer 430 includes a drawer bottom 440 and upright sides 442 that extend upward from the drawer bottom 440. Slides 441 are mounted to the upright sides 442. As shown in FIG. 17, the slides 441 are received within intermediate sleeves 435, which in turn engage the channeled rails 438 of the drawer guides 434 such that the drawer 430 slides relative to the chassis 412. During opening sliding movement of the drawer 430, the drawer slides 441 first slide forward relative to the intermediate sleeves 435. Upon the drawer reaching an intermediate open position, the slides 441 catch a forwardly-located structure (e.g., a projection, tab or slot end, not shown) of the sleeves 435 and the sleeves 435 then also slide forward relative to the drawer guides 434. Similarly, during closing sliding movement of the drawer, the drawer slides 411 first slide rearward relative to the intermediate sleeves 435; the slides catch a rearwardly-located structure (e.g., a projection, tab, or slot end, not shown) of the sleeves and the sleeves then also slide rearward relative to the drawer guides 434. The intermediate sleeves 435 function as extensions that allow the drawer to open to an extended distance such that the rear areas of the drawer are more easily accessed.

Referring to FIG. 17, the illustrated drawer 430 of the cable management panel 410 is a two-rack-unit drawer. The non-partitioned interior region 432 of the chassis 412 is sized and constructed to receive the two-rack unit drawer 430. The non-partitioned interior region 432 is also sized to receive two one-rack-unit drawers. In particular, upper and lower drawer guides (e.g., 434) can be provided in the interior region, as previously described, to accommodate two one-rack-unit drawers.

The cable management panel 410 of FIG. 17 further includes a spring lock clip 444. In the illustrated embodiment, the panel 410 includes two spring lock clips 444 (only one shown) that are carried by the drawer 430 at each side of the drawer during sliding movement. The spring lock clips 444 are secured to the slides 441 of the drawer 430. Each spring lock clip 444 has a flexible tab end 446 that engages a receiving catch 450 (schematically represented) provided on the intermediate sleeve 435. The flexible tab end 446 defines a positive mechanical lock that locks the drawer in the open position to prevent inadvertent closing movement while accessing the drawer interior. To unlock the drawer 430 from the locked open position, the flexible tab ends 446 of the clips 444 are press inward until disengaged from the catch 450; the drawer is then free to slide toward the closed position. When in the closed position, the front cover 474 is closed and latched to secure the drawer 430 within the interior of the chassis 412.

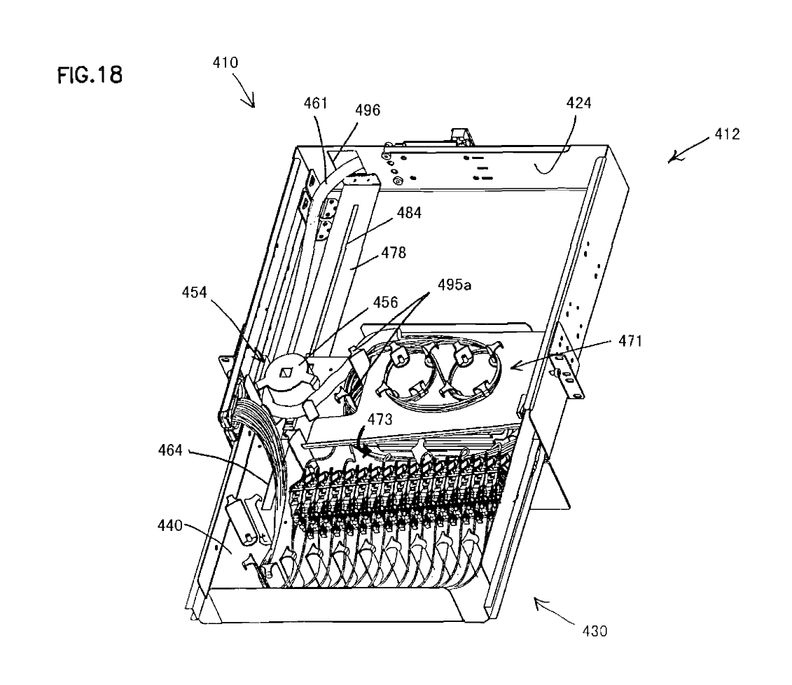

Referring now to FIGS. 16-18, the cable management panel 410 further includes a cable manager 454 that accommodates cable slack during sliding movement of the drawer 430 relative to the chassis 412. The cable manager 454 includes a radius limiter 456, a floating attachment piece 458 (FIG. 16), and a stationary plate extension 478. The radius limiter 456 is attached to projections 480 formed on the floating attachment piece 458. The floating attachment piece 458 is in turn slidingly attached to the stationary plate extension 478 through a slot 464 (FIG. 18) form in the drawer bottom 440. The radius limiter 456 of the cable manager 454 has a curved body structure 482 (FIG. 16) that also protects cables from damage by limiting cable bending beyond a minimum bend radius.

When assembled, the plate extension 478 of the cable manager 454 is located beneath the drawer 430. The floating attachment piece 458 is slidingly attached to a slot 484 formed in the plate extension 478 by tabs 481 (FIG. 16). The plate extension 478 remains stationary relative to the chassis 412 during sliding movement of the drawer 430; the slot 484 of the plate extension 478 and the slot 464 of the drawer bottom 440 permit the radius limiter 456 to slide and/or float along the drawer bottom 440 as needed to accommodate cable slack during movement of the drawer 430. The range of motion is determined in part by the slot 484 of the stationary plate extension 478 which functions to limit the movement of the radius limiter 456 and in turn permits the drawer 430 to slide relative to the radius limiter 456. Further details of a radius limiter arrangement having a similar slotted, stationary cable manager component are described in U.S. Pat. No. 5,066,149; which disclosure is incorporated herein by reference.

Referring again to FIGS. 16 and 17, a releasable attachment 466 (FIG. 16) is used to attach an end 460 of the stationary plate extension 478 to the chassis 412. In the illustrated embodiment, the attachment 466 includes a ferrous piece 445 (FIG. 16) and a magnet 447 (FIG. 17). In the illustrated embodiment, the ferrous piece 445 is a tab or flange 479 that extends upward from the stationary plate extension 478 and the magnet is secure to the rear wall 424 of the chassis 412. In the alternative, the magnet can be provided on the stationary plate extension. The attachment 466 secures the plate extension 478 in a stationary position for purposes of causing the relative movement between the drawer 430 and the radius limiter 456, as described above. The attachment also prevents inadvertent separation of the drawer 430 from the chassis 412. Yet, the attachment 466 can be selectively detached from the chassis 412 simply by pulling on the drawer with a force that overcomes the magnetic force.

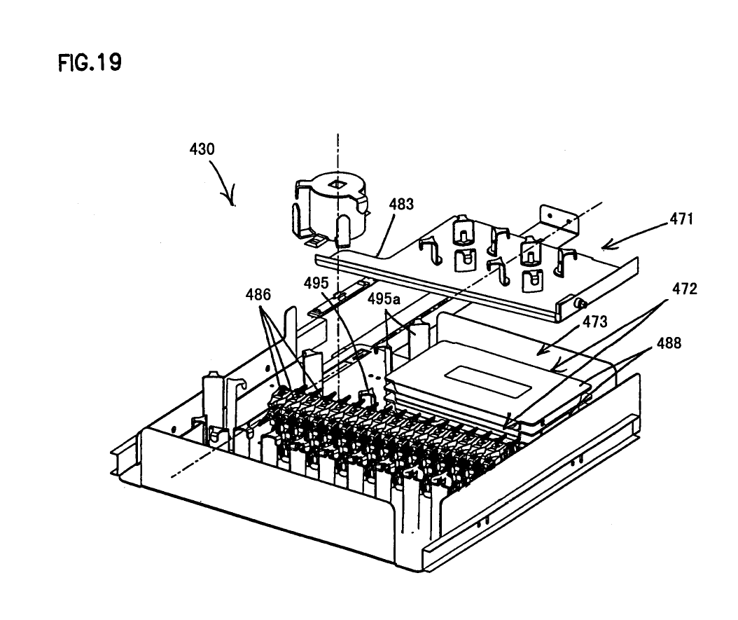

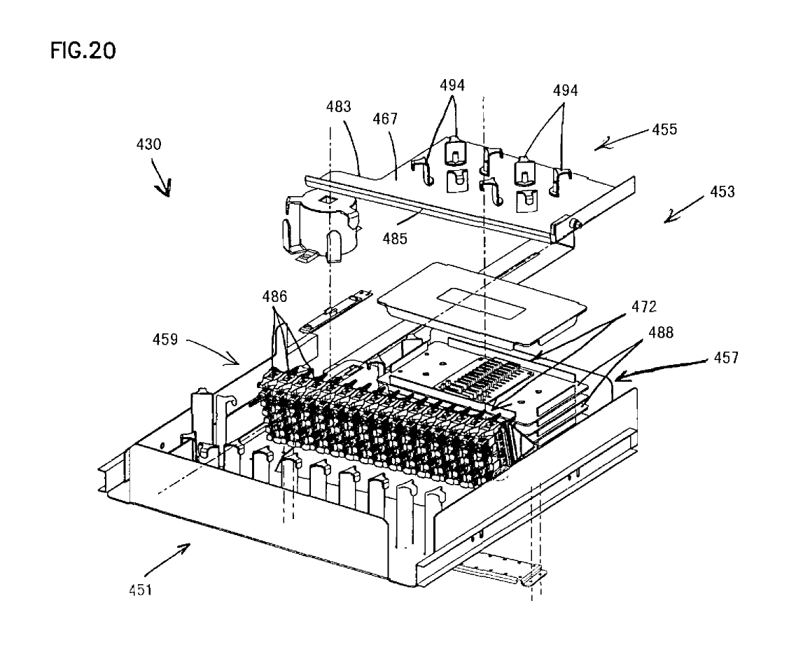

Referring now to FIGS. 19 and 20, the drawer 430 of the cable management panel 410 can include a variety of cable connections 472 that provide or accommodate telecommunications service. In the illustrated drawer embodiment, the cable connections 472 include integrated cable terminations and splice connections. The splice connections can include one or more stackable splice tray modules 488. The cable terminations can include sliding adapter packs or modules 486 having adapters that receive fiber optic connectors. Further details of an example sliding adapter arrangement that can be used in accordance with the principles disclosed are described in U.S. Pat. No. 5,497,444 and U.S. Pat. No. 6,591,051; the disclosures of which are hereby incorporated by reference. In the illustrated embodiment, the splice tray modules 488 and adapter packs 486 accommodate up to 96 cable connections or terminations. As can be understood, the present drawer 430 can be configured to provide only cable terminations, only cable splicing, or a combination of terminations and splicing. Other drawer configurations can further include attenuators, couplers, switches, and wave division multiplexers (WDMs), for example.

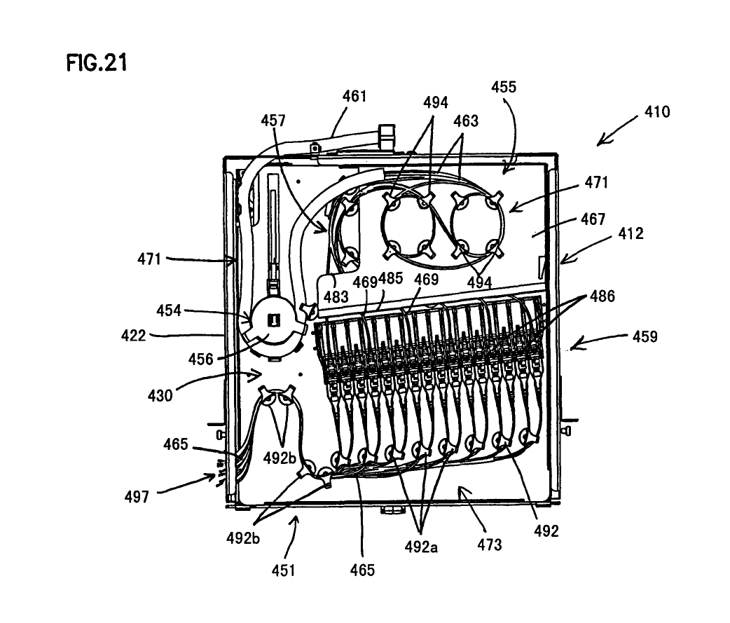

Referring now to FIGS. 20 and 21, the drawer 430 has a front 451 and a rear 453. The interior of the drawer includes a lower cable splice region 457 located at the rear 453 of the drawer, an upper cable storage region 455 located directly above the lower cable splice region 457, and a cable termination region 459 located forward of the lower cable splice region 457 and the upper cable storage region 455. The stackable splice tray modules 488 are mounted on the drawer in the lower cable splice region 457 beneath the upper cable storage region 455. The adapter packs 486 are mounted on the drawer in the cable termination region 459.

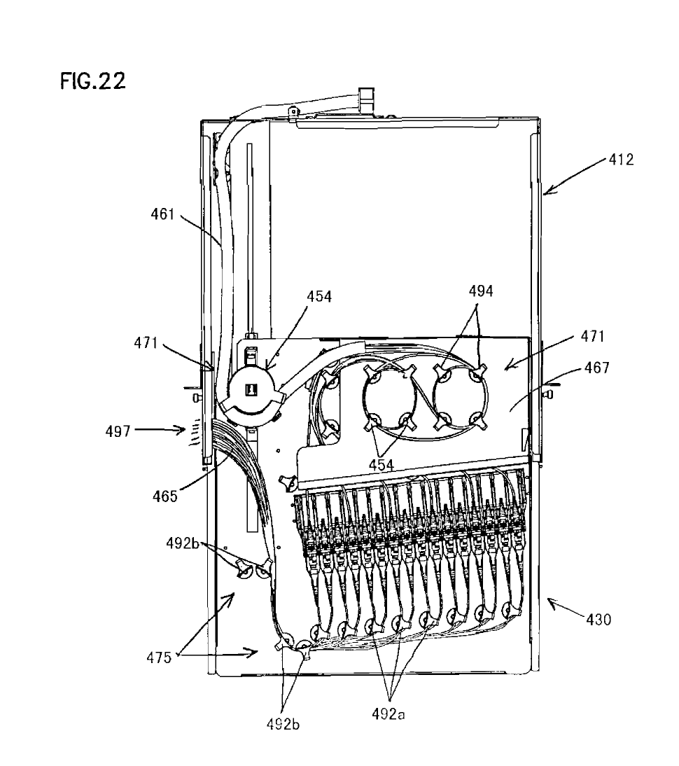

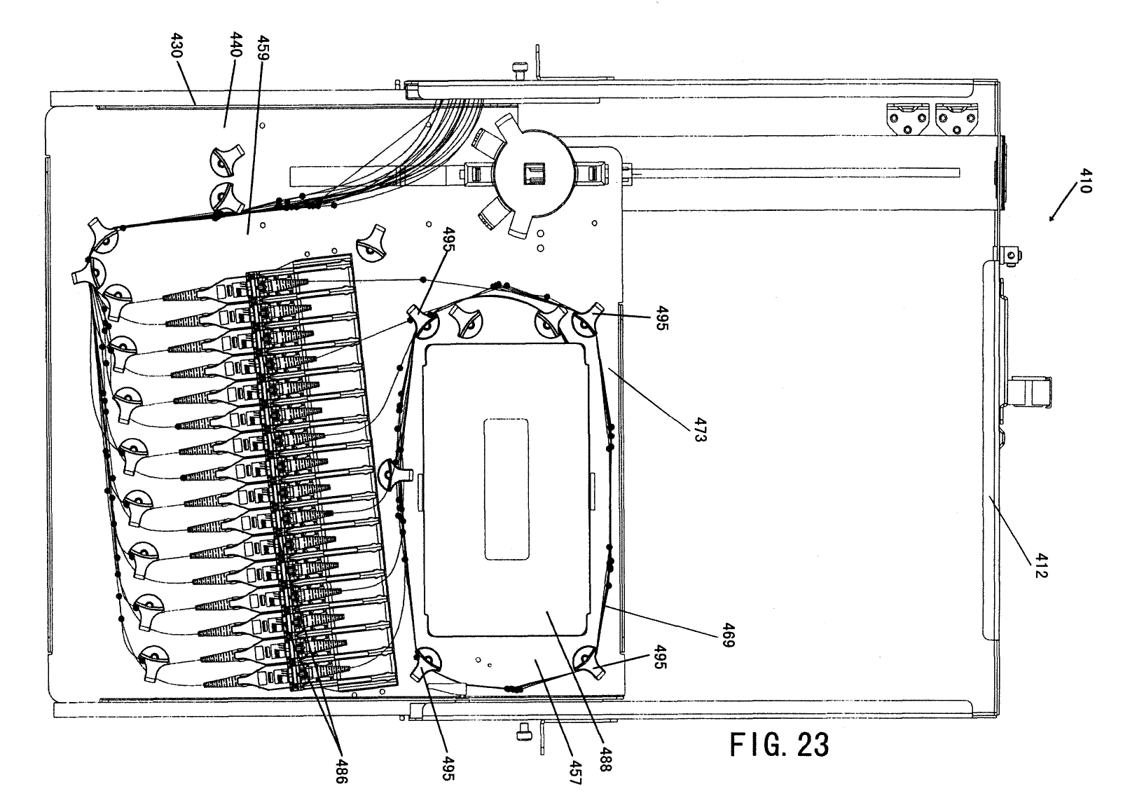

The present cable management panel 410 includes a variety of cable management elements (e.g., 454, 462) that provide bend radius protection for the cables. The cable management elements define an incoming-cable management arrangement 471 (FIG. 21), an intermediate-cable management arrangement 473 (FIG. 23), and an outgoing-cable management arrangement 475 (FIG. 22); each of which will be described in greater detail with respect to the particular cable routing arrangement provided.

Referring now to FIGS. 21 and 22, incoming cables (e.g., 461) enter the interior region 432 of the chassis 412 through a rear opening 496 (FIG. 18) formed in the rear wall 424 of the chassis 412. From the rear opening 496, the incoming cable 461 is directed toward the incoming-cable management arrangement 471. The incoming-cable management arrangement 471 includes an incoming cable pathway defined by the cable manager 454 and a plurality of fixed cable guides 494 mounted to a top surface of a cable storage plate or tray 467 (e.g., a dividing plate or tray). In an alternative embodiment, a single cable guide or one or more large diameter spools, for example, can be provided on the cable storage tray 467. The cable storage tray 467 is carried by the drawer 430 and partitions the interior of the drawer into the upper cable storage region 455 and the lower cable splice region 457 (see FIG. 20).

As shown in FIG. 21 and with reference to the incoming cable pathway, the incoming cable 461 is routed toward the cable manager 454 and wraps about the radius limiter 456 of the cable manager 454. From the cable manager 454, the incoming cable 461 or fibers 463 of the incoming cable 461 are directed toward the cable guides 494 of the cable storage tray 467. Excess length or slack of the incoming cable 461 or fibers 463 is stored around the cable guides 494 of the incoming-cable management arrangement 471. The fiber 463 of the incoming cable 461 are then routed from the upper cable storage region 455 to the lower cable splice region 457 where the fibers are spliced with intermediate cables or pigtails 469 (FIG. 23).

Referring to FIG. 23, the intermediate cable management arrangement 473 defines an intermediate cable pathway. With reference to the intermediate cable management arrangement 473 and the intermediate cable pathway, the pigtails 469 extend from the cable splice region 457 of the drawer to the cable termination region 459. The ends of the pigtails 469 are attached to rear connection ends of the adapter modules 486. Excess length or slack of the pigtails 469 is stored around fixed cable guides 495 of the intermediate-cable management arrangement 473. The cable guides 495 are mounted to the bottom 440 of the drawer in an arrangement around the entire perimeter of the splice tray modules 488. Longer lengths of excess slack can be wrapped around the entire perimeter of the splice tray modules 488 as many times as needed to accommodate the excess slack length.

Referring back to FIG. 19, a portion of the incoming-cable management arrangement 471 is located directly over or above the intermediate-cable management arrangement 473. A majority of the cable guides 495 of the intermediate-cable management arrangement 473 are accordingly of a height that permits placement of the tray 467 of the incoming-cable management arrangement 471 over the intermediate-cable management arrangement 473. As illustrated in FIG. 18, the tray 467 separates the incoming-cable management arrangement 471 from the intermediate-cable management arrangement 473 to provide the user with improved cable storage organization and easier identification of cables. In the alternative, the incoming-cable management arrangement 471 can be located below the intermediate-cable management arrangement 473, in accordance with the principles disclosed.

Referring to FIG. 18, in the illustrated embodiment, two of the cable guides 495a (see also FIG. 19) mounted to the bottom 440 of the drawer are utilized in both the incoming-cable management arrangement 471 and the intermediate-cable management arrangement 473. The cable guides 495a accordingly have a height that extends above the tray 467. The cable guides 495a assist in transitioning fibers 463 of the incoming cable 461 from the upper cable storage region 455 to the lower cable splice region 457. Accordingly, the fibers 463 are generally routed about an upper portion of the cable guides 495a; pigtails 469 can also be routed about a lower portion of the cable guides 495a. The taller cable guides 495a are located within a notch 483 (FIG. 20) formed in the cable storage tray 467. The notch 483 is located rearward of a front edge 485 of the tray 467. Referring to FIG. 21, the front edge 485 extends a length that generally corresponds to the length at which the sliding adapter packs 486 extend.

Referring still to FIG. 21, the outgoing-cable management arrangement 475 includes an outgoing cable pathway. The outgoing-cable management arrangement 475 organizes outgoing cables 465, which are connected to the pigtails 469 by way of the adapter modules 486. The outgoing cables (e.g., patch cords) 465 exit the interior region 432 of the chassis through a side opening 497 (see also FIG. 15) formed in one of the sidewalls 422 of the chassis adjacent to the front opening 417 of the chassis 412. With reference to the cable management arrangement 475 and the outgoing cable pathway, the outgoing cables 465 are attached to and routed from front connection ends of the adapter modules 486 through fixed guides 492 that direct the cables 465 in a direction toward the side of the drawer with the side opening 497. The guides 492 include an array of forward guides 492a aligned to correspond to the adapter packs 486, and additional sideward guides 492b that guide the cables 465 to the side opening 497.

As illustrated in FIGS. 21 and 22, cables exit the chassis through the side opening 497 when the drawer is in the closed position (FIG. 21) and when the drawer is in the open position (FIG. 22). When the drawer 430 is closed (FIG. 21), the side opening 497 of the chassis through which the cables 465 exit is located sideward of or laterally adjacent to the array of forward guides 492a. The additional sideward guides 492b create an S-curved cable routing pathway (a pathway having a 180-degree curve) that accommodates the length of the exiting fiber cables 465 and further prevents the cables from exceeding a minimum bend radius. When the drawer is open (FIG. 22), the side opening 497 of the chassis through which the cables 465 exit is located rearward of the array of guides 492a. The additional sideward guides 492b are positioned to allow of the outgoing cable pathway to transform from the S-curved routing pathway to a generally straightened routing pathway that extends rearward. As can be understood, when the drawer moves from the open position to the closed position, the generally straightened routing pathway transforms back to the S-curved routing pathway.

Referring back to FIG. 15, in one embodiment, a cable retainer 439 is provided within the side opening 497 of the chassis 412. The cable retainer 439 provides edge protection for the cables 465 exiting the chassis. The cable retainer 439 further has a ring shape defined by fingers 449 having a slot opening 443 therebetween. The slot opening 443 accommodates placement of cables within the cable retainer 439. The fingers 449 retain the cables within the side opening 497 of the chassis during sliding movement of the drawer 430. Accordingly, the exiting cables 465 exit the chassis at a fixed location, as opposed to a location that moves relative to the chassis during sliding movement of the drawer.

The above specification provides a complete description of the present invention. Since many embodiments of the invention can be made without departing from the spirit and scope of the invention, certain aspects of the invention reside in the claims hereinafter appended.

1. A cable management panel, comprising:
a) a chassis having a front, a rear, and opposite sides, the rear defining a rear opening, one of the sides defining a side opening;
b) a drawer that slides relative to the chassis, the drawer defining an interior, the interior of the drawer including a cable storage region, a cable splice region, and a cable termination region, the cable storage region being located above the cable splice region;
c) a plurality of adapters mounted on the drawer in the cable termination region;
d) at least one splice tray mounted on the drawer in the cable splice region;
e) a radius limiter for reversing a direction of an incoming cable; and
f) cable guides located within the interior of the drawer, the cable guides at least partly defining an incoming cable pathway, an intermediate cable pathway, and an outgoing cable pathway, wherein:
i) the incoming cable pathway extends from the rear opening of the chassis to the cable storage region of the drawer, and from the cable storage region to the cable splice region of the drawer;
ii) the intermediate cable pathway extends from the cable splice region of the drawer to the cable termination region, the intermediate cable pathway including slack storage that extends around the perimeter of the at least one splice tray; and
iii) the outgoing cable pathway extends from the cable termination region to the side opening of the chassis, wherein cables exit the chassis through the side opening when the drawer is in the open position and when the drawer is in the closed position, the outgoing cable pathway being defined by:
1) an array of forward cable guides aligned to correspond to the plurality of adapters; and
2) sideward cable guides that guide exiting cables to the side opening of the chassis;
3) wherein the side opening of the chassis is located laterally adjacent the array of forward guides when the drawer is closed, and wherein the side opening of the chassis is located rearward of the array of forward guides when the drawer is open, the sideward cable guides creating an S-curved cable routing that accommodates the length of exiting cables when the drawer is closed, the sideward cable guides being positioned to permit the S-curved cable routing of the outgoing cable pathway to transform from the S-curved cable routing to a generally straightened cable routing when the drawer is open.

2. The cable management panel of claim 1, wherein the chassis is a two-rack-unit chassis having a non-partitioned chassis interior, and wherein the drawer is a two-rack-unit drawer, at least a portion of the two-rack-unit drawer interior being partitioned.

3. The cable management panel of claim 1, further including a dividing plate carried by the drawer that partitions the cable storage region of the drawer from the cable splice region.

4. The cable management panel of claim 3, wherein the incoming cable pathway is defined by the radius limiter and cable guides mounted to a top surface of the dividing plate.

5. The cable management panel of claim 1, wherein the radius limiter floats relative to the sliding movement of the drawer, and further including a stationary plate extension to which the radius limiter is slidingly attached, an end of the stationary plate extension being secured to the chassis.

6. The cable management panel of claim 5, wherein the drawer includes a bottom surface having a slot formed therein, the stationary plate extension being positioned beneath the drawer, the radius limiter being slidingly attached to the stationary plate extension through the slot in the bottom surface of the drawer.

7. The cable management panel of claim 5, wherein the end of the stationary plate extension is secured to the chassis by a magnet.

8. The cable management panel of claim 1, further including a cable retainer located within the side opening of the chassis that retains cables exiting the chassis through the side opening.

9. The cable management panel of claim 8, wherein the cable retainer has fingers that define a slot opening therebetween, the slot opening accommodating placement of exiting cables within the cable retainer.

10. The cable management panel of claim 1, wherein the chassis is a two-rack-unit chassis having a non-partitioned chassis interior, the chassis including a first pair of drawer guides and a second pair of drawer guides, the non-partitioned chassis interior being sized to receive two one-rack-unit drawers and sized to receive one two-rack-unit drawer.

11. A cable management panel, comprising:
a) a chassis having a front, a rear, and opposite sides, the rear defining a rear opening, one of the sides defining a side opening;
b) a drawer that slides relative to the chassis, the drawer having a front and a rear, the drawer defining an interior, the interior of the drawer including an upper cable storage region located at the rear of the drawer, a lower cable splice region located beneath the upper cable storage region, and a cable termination region located forward of the upper cable storage region and the lower cable splice region;
c) a plurality of adapters mounted on the drawer in the cable termination region;
d) at least one splice tray mounted on the drawer in the lower cable splice region;
e) a dividing plate carried by the drawer that partitions the interior of the drawer into the upper cable storage region and the lower cable splice region;
f) a radius limiter for reversing a direction of an incoming cable; and
g) cable guides located within the interior of the drawer, the cable guides defining an incoming cable pathway, an intermediate cable pathway, and an outgoing cable pathway, wherein:
i) the incoming cable pathway extends from the rear opening of the chassis to the upper cable storage region of the drawer, and from the upper cable storage region to the lower cable splice region of the drawer, the incoming cable pathway being defined at least in part by the radius limiter and by cable guides mounted to a top surface of the dividing plate;
ii) the intermediate cable pathway extends from the lower cable splice region of the drawer to the cable termination region, the intermediate cable pathway being defined at least in part by cable guides mounted around the perimeter of the at least one splice tray; and
iii) the outgoing cable pathway extends from the cable termination region to the side opening of the chassis, wherein cables exit the chassis through the side opening when the drawer is in the open position and when the drawer is in the closed position, the outgoing cable pathway being defined at least in part by:
1) an array of forward cable guides aligned to correspond to the plurality of adapters; and
2) sideward cable guides that guide exiting cables to the side opening of the chassis;
3) wherein the side opening of the chassis is located laterally adjacent the array of forward guides when the drawer is closed, and wherein the side opening of the chassis is located rearward of the array of forward guides when the drawer is open, the sideward cable guides creating an S-curved cable routing that accommodates the length of exiting cables when the drawer is closed, the sideward cable guides being positioned to permit the S-curved cable routing of the outgoing cable pathway to transform from the S-curved cable routing to a generally straightened cable routing when the drawer is open.

12. The cable management panel of claim 11, wherein the chassis is a two-rack-unit chassis having a non-partitioned chassis interior, and wherein the drawer is a two-rack-unit drawer.

13. The cable management panel of claim 11, wherein the radius limiter floats relative to the sliding movement of the drawer, and further including a stationary plate extension to which the radius limiter is slidingly attached, an end of the stationary plate extension being secured to the chassis.

14. The cable management panel of claim 13, wherein the drawer includes a bottom surface having a slot formed therein, the stationary plate extension being positioned beneath the drawer, the radius limiter being slidingly attached to the stationary plate extension through the slot in the bottom surface of the drawer.

15. The cable management panel of claim 13, wherein the end of the stationary plate extension is secured to the chassis by a magnet.

16. The cable management panel of claim 11, further including a cable retainer located within the side opening of the chassis that retains cables exiting the chassis through the side opening.

17. The cable management panel of claim 16, wherein the cable retainer has fingers that define a slot opening therebetween, the slot opening accommodating placement of exiting cables within the cable retainer.

18. The cable management panel of claim 11, wherein the chassis is a two-rack-unit chassis having a non-partitioned chassis interior, the chassis including a first pair of drawer guides and a second pair of drawer guides, the non-partitioned chassis interior being sized to receive two one-rack-unit drawers and sized to receive one two-rack-unit drawer.

19. A cable management panel, comprising:
a) a chassis having a rear wall and opposite sidewalls, the chassis defining an interior, the interior being sized to receive two one-rack-unit sliding drawers, and also being sized to receive one two-rack-unit sliding drawer;
b) first and second pairs of drawer guides provided within the interior of the chassis;
c) at least a first sliding drawer mounted within a front opening of the chassis, the first sliding drawer being engaged with one of the first and second pairs of guides to permit sliding movement of the drawer relative to the chassis; and
d) cable connections provided on the sliding drawer;
e) wherein cables connected to the cable connection provided on the drawer enter the interior of the chassis through a rear opening formed in the rear wall of the chassis, and wherein cables exit the interior of the chassis through a side opening formed in one of the sidewalls of the chassis.

20. The cable management panel of claim 19, wherein the first and second pairs of drawer guides include an upper pair of channeled guides and a lower pair of channeled guides, each pair of channeled guides being provided on the sidewalls of the chassis.

21. The cable management panel of claim 19, wherein the first sliding drawer includes a cable manager having a radius limiter that floats relative to the sliding movement of the drawer.

22. The cable management panel of claim 21, wherein the cable manager includes a stationary plate extension to which the radius limiter is slidingly attached, an end of the stationary plate extension being secured to the chassis.

23. The cable management panel of claim 22, wherein the end of the stationary plate extension is secured to the chassis by a magnet.
